(19) United States
(12) Patent Application Publication
(10) Pub. No.: US 2008/0009425 A1
(43) Pub. Date: Jan. 10, 2008

(54) PROPPANT AND METHOD OF FORMING PROPPANT

(76) Inventor: Elena Pershikova, Moscow (RU)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/768,494

(22) Filed: Jun. 26, 2007

(30) Foreign Application Priority Data
Jul. 7, 2006 (RU) 2006124277

(51) Int. Cl. C09K 8/80

(52) U.S. Cl. 507/273

(57) ABSTRACT

A proppant material is formed from a solid particle having at least one phase of a boron-containing component. The boron-containing component may be an Al₂O₃—B₂O₃ component and/or an Al₂O₃—B₂O₃—SiO₂ component, which may be a chemical compound, a solid solution or a eutectic mixture. The proppant material may be formed by comminuting aluminum-bearing and boron-bearing starting components. The aluminum-bearing and boron-bearing starting components are mixed together and granulated to form a granulated material. The granulated material is dried and fired to form at least one phase of a boron-containing component.

This application claims foreign priority benefits under 35 U.S.C. §119(a)-(d) to Russian Patent Application No. 2006124277, filed on Jul. 7, 2006.

### BACKGROUND

The present invention relates generally to the oil and gas industry, more particularly, to proppants, and still more particularly to ceramic granulated propping agents used for hydrofracturing treatment of subterranean formations for the stimulation of oil and gas production from wells.

For a hydraulic fracturing treatment, proppant is mixed with a hydraulic fracturing fluid and the resulting system is pumped into the recently developed fracture in the formation. After the process is completed, the proppant is deposited in the fracture. The deposited proppant plays a dual role in that it prevents the closuring of fracture walls and also creates a porous structure for better transport of hydrocarbon fluid from the formation to the wellbore.

The key properties of proppant are strength, particulate size, chemical resistance, density, and permeability of the structure for agglomerates of proppant particles. Properties of proppant dictate the choice for the proper treatment. In turn, proppant properties depend mainly on the phase composition of input materials and the structure formed after proppant production procedure. The proppant production comprises the stages of grinding and mixing of input raw materials, pelletizing, drying and firing of granules at high temperatures. Traditional components for proppant production are different types of kaolin and bauxites.

A method is disclosed in U.S. Pat. No. 4,894,285, wherein a proppant with a density of 2.75-3.4 g/cm³ (and operable at the pressure of 2,000-10,000 psi) is fabricated from a mixture of bauxites and clays, and which is followed by firing at a temperature of 1350-1550° C.

A method is disclosed in U.S. Pat. No. 4,921,821 for the fabrication of proppant with a density below 3.0 g/cm³. The fabrication includes pelletizing and further firing of kaolin clays.

In U.S. Pat. No. 5,120,455, a method of proppant production is described, wherein the proppant has a density below 3.0 g/cm³ and a pack permeability of more than 100,000 millidarcy at a pressure of 10,000 psi. The proppant is made from materials including aluminum oxide present in the amount from 40 to 60%.

U.S. Pat. No. 5,188,175 discloses a method of production of proppant having a density of 2.2-2.60 g/cm³ and a packing permeability exceeding that of sand. The proppant is fabricated from raw materials that include 25-40 wt % alumina.

### DETAILED DESCRIPTION

The process of making a proppant structure from traditional materials is described in technical literature. The key properties of proppant depend mainly on phase composition, more specifically, presented crystals of corundum and/or mullite, and/or aluminosilicate glass.

The present invention provides a proppant material(s) having at least one or more phases of a boron-containing component. The boron-containing component may include one or more phases of an Al₂O₃—B₂O₃ component and/or an Al₂O₃—B₂O₃—SiO₂ component. The Al₂O₃—B₂O₃ component may be a chemical compound, a solid solution or a eutectic mixture. The Al₂O₃—B₂O₃—SiO₂ component may be a chemical compound, which may be a triple or quadruple chemical compound, a solid solution or a eutectic mixture. The boron-containing component may be a boron glass, aluminum borate, and chemical compounds, solid solutions or eutectic mixes of borates and aluminum silicates. Such phase or phases may have optical constants that are different from that for mullite (3Al₂O₃-2SiO₂) and corundum (Al₂O₃). These boron-containing phases in the proppant composition provide beneficial properties to the proppant, such as higher proppant strength. Non-limiting examples of various phase compositions of proppant material may include those having a primarily crystalline aluminum borate phase, a proppant having a continuous sequence of solid solutions of aluminum borate and mullite, along with aluminoboratesilicate glass, and a proppant with aluminum borate phase and a solid solution of aluminum borate and mullite.

In one particular embodiment, the proppant may have an apparent material density of from about 3 g/cm³ or less, more particularly, from about 2.75 g/cm³ or less, and still more particularly, from about 2.5 g/cm³ or less, with the amount of crushed proppant having an 12/18 mesh particle size and subjected to a crushing pressure of 69 MPa that passes through an 18 mesh sieve being from about 25%, 20%, 15%, 10% or less.

It should be understood that throughout this specification, when a concentration or amount range is described, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventor(s) appreciate and understand that any and all data points within the range are to be considered to have been specified, and that the inventor(s) have possession of the entire range and all points within the range.

The proppant materials of the invention are formed by first grinding or otherwise comminuting and mixing the starting components. The starting components may each be comminuted, by grinding or otherwise, separately or together. The first starting component may include an aluminum- or magnesium-containing component. Non-limiting examples may include alumina, kaolin (Al₂Si₂O₅(OH)₄), bauxite, etc. The second starting component is the element of boron. The boron starting component may be provided from a variety of boron sources, for example, boric acids, borate salts, oxides of boron, borate minerals, etc.

The next step is to form granules or particles of the desired size by either a wet or dry method. Such methods are well known to those skilled in the art. The formed granules are dried at temperatures up to about 200° C. or higher, more particularly, from about 100 to about 200° C., still more particularly, from about 150° C. to about 200° C. and then fired at temperatures in the range from about 200 to about 1550° C. or higher, more particularly, from about 700, 800, 900, 1000, 1100 or 1200 to about 1400, 1500 or 1550° C.

The goal of introducing boron-bearing components into the proppant is to shift the process of phase formation from traditional aluminosilicates to the phases mentioned above. This is done for lower energy consumption and to attain a higher proppant strength.

The formed proppant materials may be introduced into a wellbore that penetrates a subterranean formation in a suitable carrier fluid, along with any additives, having a sufficient viscosity or pumped at a rate to suspend the proppant materials. The carrier fluid containing the proppant materials may be introduced at a pressure at or above the fracture pressure of the formation being treated.

The following examples serve to further illustrate the invention.

### EXAMPLES

### Example 1

Technical-grade alumina with an aluminum oxide content above 98% by weight was mixed and ground down to the alumina particle size of 10 microns with boric acid. The mix included 162 kg of alumina and 29 kg of boric acid. The ground mixture was granulized using the dry method. The resulting granules having a particle size of from about 0.2 to about 2 mm were dried at a temperature of from about 150 to about 200° C., screened into different particle size fractions and fired at a temperature of from about 1200 to about 1550° C., and then the product fractions were selected. The main phase of the proppant after firing was crystalline aluminum borate.

### Example 2

Bauxite was thermally treated to remove any chemically bound water. The bauxite was comprised of at least 68-72% by weight of alumina. The bauxite was ground together with boric acid to the size of about 15 microns. The mix included 170 kg of alumina and 19 kg of boric acid. The ground mixture was granulized using the dry method. The resulting granules had a particle size of about 0.2 to about 2 mm and were dried at a temperature of from about 150 to about 200° C., screened into different particle size fractions and fired at a temperature of from about 1100 to about 1400° C., and then the product fractions were selected. The main phase of the proppant after firing was crystalline aluminum borate.

### Example 3

Kaolin having an alumina content of about 40-45% by weight was mixed in water with sodium tetraborate into a stable water slurry. The mixture had 170 kg of clay and 19 kg sodium tetraborate. The slurry was dispersed through a nozzle for production of granulate. The resulting granulate had a particle size of from about 0.6 to about 1.4 mm and was dried at a temperature of from about 150 to about 200° C., screened into different particle size fractions and fired at a temperature of from about 800 to about 1250° C., and then the product fractions were selected. The phase composition of the resulting proppant material exhibited a continuous sequence of solid solutions of aluminum borate and mullite, as well as aluminoboratesilicate glass.

### Example 4

Bauxite was thermally treated to remove the chemically bound water. The bauxite was comprised of about 60-72% by weight of alumina. The bauxite was mixed with natural bauxite and colemanite and ground down so that the average size of bauxite particles was about 15 microns. The mixture comprised about 142 kg of heat-treated bauxite, 10 kg on untreated bauxite, and 38 kg of boric acid. The mixture was granulated using the dry method for 2 minutes using water as a temporary technical binder in the amount of 4% wt. The rotation speed for the pelletizer shaft was around 30 m/s. The resulting granulate had a particle size of from about 0.2 to about 2 mm and was dried at a temperature of from about 150 to about 200° C., screened into different particle size fractions and fired at a temperature of from about 1100 to about 1400° C., and then the product fractions were selected. The phase composition of the proppant material was comprised of aluminum borate and solid solutions of aluminum borate and mullite.

### Example 5

Natural bauxite with an alumina content about 60-72% by weight was ground down to an average particle size of about 15 microns, and then mixed with bentonite clay and boron oxide. The mixture comprised 130 kg of heat-treated bauxite, 20 kg of bentonite clay and 45 kg of boric acid. The mixture was granulated using the dry method for 2 minutes with water as a temporary technical binder in the amount of 4% wt. and the rotation speed for the pelletizer shaft at about to 30 m/s. The resulting granulate had a particle size of from about 0.2 to about 2 mm and was dried at a temperature of about 150 to about 200° C., screened into different particle size fractions and fired at a temperature of about 1100 to about 1400° C., and then the product fractions were selected. The phase composition of material was aluminum borate and solid solutions of aluminum borate and mullite.

The proppant properties of the various samples from Examples 1-5 with mesh sizes of 12/18 are summarized in Table 1 below.

TABLE 1

| | Percentage of crushed | |
|---|---|---|
| | proppant passing through | |
| | the sieve with 18 mesh | |
| Example | (crushing at 69 MPa) | Apparent material density, (g/cm³) |
| 1 | 8 | 2.0 |
| 2 | 10 | 2.2 |
| 3 | 13 | 2.3 |
| 4 | 7 | 1.9 |
| 5 | 11 | 2.5 |

What is claimed is:

1. A proppant material comprising a solid particle having at least one phase of a boron-containing component of at least one of an Al₂O₃—B₂O₃ component and a Al₂O₃—B₂O₃—SiO₂ component.

2. The proppant material of claim 1, wherein:
the at least one of the Al₂O₃—B₂O₃ component and the Al₂O₃—B₂O₃—SiO₂ component is a chemical compound, a solid solution or a eutectic mixture.

3. The proppant material of claim 1, wherein:
at least one phase is formed from an Al₂O₃—B₂O₃ component and at least one other phase is formed from an Al₂O₃—B₂O₃—SiO₂ component.

4. The proppant material of claim 1, wherein:
the proppant material has an apparent density of 3 g/cm³ or less.

5. The proppant material of claim 1, wherein:
the at least one phase of a boron-containing component has an optical constant that is different from that for mullite and corundum.

6. The proppant material of claim 1, wherein:
the proppant material further contains at least one of a mullite or corundum phase.

7. A method of forming a proppant material comprising:
comminuting aluminum-bearing and boron-bearing starting components;
mixing the aluminum-bearing and boron-bearing starting components together;
granulating the mixed starting components to form a granulated material;
drying and firing the granulated material to form at least one phase of a boron-containing component of at least one of an Al₂O₃—B₂O₃ component and a Al₂O₃—B₂O₃—SiO₂ component.

8. The method of claim 7, wherein:
at least one phase is formed from an Al₂O₃—B₂O₃ component and at least one other phase is formed from an Al₂O₃—B₂O₃—SiO₂ component.

9. The method of claim 7, wherein:
the at least one of the Al₂O₃—B₂O₃ component and the Al₂O₃—B₂O₃—SiO₂ component is a chemical compound, a solid solution or a eutectic mixture.

10. The method of claim 8, wherein:
the firing is carried out at a temperature of from about 200-1550° C.
